(19) United States
(12) Patent Application Publication
(10) Pub. No.: US 2017/0056279 A1
(43) Pub. Date: Mar. 2, 2017

(54) NERVE SUPPRESSION DEVICE

(71) Applicant: Francis Jack Wright, Buellton, CA (US)

(72) Inventor: Francis Jack Wright, Buellton, CA (US)

(21) Appl. No.: 15/246,849

(22) Filed: Aug. 25, 2016

Related U.S. Application Data
(60) Provisional application No. 62/209,696, filed on Aug. 25, 2015.

(51) Int. Cl. A61H 9/00; A61H 1/00

(52) U.S. Cl. CPC A61H 9/005; A61H 1/008; A61H 2201/0207; A61H 2201/0221; A61H 2205/106

(57) ABSTRACT

A nerve suppression device is provided that focuses pressure on one or more nerves when the nerve suppression device is stretched over an appendage such as a lower leg. Raised ribs that correspond to nerves in the lower leg may be positioned on an inner surface of the device to focus pressure on the nerves. This may alleviate or eliminate debilitating cramping or other ailments in the lower leg, or any other appendage.

### CROSS-REFERENCE TO RELATED APPLICATIONS

This application claims priority under 35 U.S.C. §119(e) to U.S. Provisional Patent Application Ser. No. 62/209,696 filed Aug. 25, 2015, which is incorporated herein in its entirety by reference.

### FIELD OF THE INVENTION

The present invention relates to a nerve suppression device for exerting a pressure on an appendage to relieve pain, discomfort and immobility, and specifically along the nerve location on the appendage.

### BACKGROUND OF THE INVENTION

Nocturnal leg cramps are a common periodic limb muscle disorder, becoming more prevalent with advancing age. A typical episode begins with the sudden onset of a painful cramping sensation in a calf muscle during sleep. The affected muscle, when palpated, is firm and contracted. The episode can be rather brief or somewhat extended and may recur intermittently throughout the night. The person is awakened from sleep, and if able, may get out of bed in an attempt to alleviate the pain by exercise, massage, hot/cold packs or other time consuming methods that further ruins a sound night's sleep. Nocturnal leg cramps can occur sporadically or on a frequent and regular basis. Intensity can range from simply annoying to excruciating pain.

An instability in the membrane electrical potentials of the nerves of the legs may cause abnormal muscle contractions or cramping. Factors which increase the likelihood of nocturnal leg cramps may include dehydration, blood electrolyte abnormalities, medications, peripheral arterial disease, advancing age, and excessive physical activity.

Management of nocturnal leg cramps may include firm massage and stretching of the affected muscle during or after a cramping episode, which may be difficult or impossible for the elderly or disabled in the middle of the night or due to physical limitations. Preventative measures such as hydration, stretching before bed, and oral agents such as calcium, magnesium, potassium, and quinine are not reliably effective, and can be associated with side-effects such as intestinal upset, allergic reactions, and even liver toxicity. Thus, there is a need for a safer and more effective treatment of nocturnal leg cramps, restless leg syndrome, and other ailments associated with nerves.

### SUMMARY OF THE INVENTION

It is therefore an aspect of the present invention to provide a nerve suppression device that concentrates pressure exerted by the device onto one or more nerves in an appendage such as the lower leg to alleviate or eliminate cramping or other ailments.

It is one aspect of the present invention to provide a nerve suppression device that has one or more raised ribs positioned on an inner surface of the device. These ribs may be shaped like a particular nerve or nerves. Thus, when a user stretches the device over an appendage such as the lower leg, the ribs focus the pressure exerted by the device onto the particular nerve or nerves. The ribs may have a continuous area to cover all of a particular nerve structure. In other embodiments, the ribs may have an area that only explicitly covers particular nerve(s), or portions thereof, and therefore, in some embodiments, the ribs may be disjointed or piecemeal as nerve systems can vary significantly in shape and location.

It is another aspect of the present invention to provide a nerve suppression device that is configured to regulate the thermal state of an appendage in the location of a nerve or nerves. In some embodiments, a rib sets the sheath or body of the device off of a surface of an appendage to create an air volume between the device and the appendage. This air volume can trap heated air in a cold environment to retain heat on the nerve, and the air volume can expel heated air in a hot environment to dissipate heat from the nerve. To trap heated air, the nerve suppression device may have ribs that do not extend to either end of the sheath or device. To expel heated air, the nerve suppression device may have a rib that extends to either end of the sheath or device such that heated air can exit through apertures created at either end of the sheath or device. In addition, apertures in the sheath can be positioned adjacent to the rib and can vent heated air from the air volume.

It is another aspect of the present invention to provide a nerve suppression device that is impregnated with proprietary compounds that aid in the alleviation or elimination of cramping or other ailments. These proprietary compounds may include potassium, manganese, calcium, and/or other topically-active compounds. Various portion pad applicators of the device may be impregnated with proprietary compounds including a rib or the entire device. Further, applicators may be selectively removable to replenish proprietary compounds.

It is another aspect of the present invention to retrofit existing devices or sheaths with ribs to provide a nerve suppression device as described herein. The ribs in embodiments of the present invention may be made from additional fabric or material that is woven in a single location on a sheath to create a rib that rises above an inner or outer surface of the sheath. Thus, existing fabrication methods may be employed to create embodiments of the present invention in a first instance or to retrofit existing devices or sheaths to provide a suppression device that incurs the benefits described herein.

Another aspect is a method of treating nocturnal leg cramps and other similar ailments with a portable, self-administered device comprising a sheath having a first end and a second end where at least one aperture is positioned at the ends such that the sheath is configured to receive an appendage through the at least one aperture. The sheath stretches to a second sizes once an appendage is positioned in the sheath. The resilient nature of the sheath provides a sheath pressure on the surface of the appendage. Raised ribs are positioned on an inner surface of the sheath and are shaped to align with like nerve structures. The ribs focus the pressure provided by the sheath to a rib pressure that is greater than the general sheath pressure. The ribs are placed over the corresponding nerve structure on the appendage and provide treatment for nocturnal leg cramps and other similar ailments.

One particular embodiment of the present invention is a nerve suppression device that comprises a resilient sheath having a first end and a second end where a first aperture is positioned at the first end and a second aperture is positioned at the second end. An inner surface of the resilient sheath defines a partially enclosed volume adapted to receive an appendage, and the resilient sheath is expandable between a first position where the partially enclosed volume is a first volume and a second position where the partially enclosed volume is a second volume. The second volume is larger than the first volume, and the resilient sheath is configured to exert a sheath pressure on the appendage where the sheath pressure is greater than atmospheric pressure. As an example, the sheath pressure may be between approximately 5 and 50 mmHg greater than atmospheric pressure. At least one raised rib is positioned on the inner surface of the resilient sheath, and at least one raised rib configured to exert a rib pressure on the appendage when the resilient sheath is in the second position. The rib pressure being greater than the sheath pressure.

In some embodiments, at least one raised rib is configured to be positioned over at least one nerve such as a superficial peroneal, deep peroneal, saphenous, posterior tibial, sural nerve or other such nerve(s) as may be deemed effective in suppressing pain in the appendage.

In various embodiments, a first raised rib is configured to be positioned over the superficial peroneal nerve, the deep peroneal nerve, and the saphenous nerve of the appendage, and a second raised rib is configured to be positioned over the tibial nerve and the sural nerve of the appendage. In other embodiments, a rib may be positioned over each of the superficial peroneal nerve, the deep peroneal nerve, the saphenous nerve, the tibial nerve, and the sural nerve of the appendage.

In different embodiments, an interconnection means is positioned along a longitudinal length of the resilient sheath, the interconnection means configured to join two longitudinal sides of the resilient sheath to form the partially enclosed volume. In various embodiments, an air volume is positioned adjacent to the at least one raised rib, wherein the at least one rib is configured to deflect an outer surface of the appendage such that the air volume is at least partially defined by the at least one raised rib and the inner surface of the resilient sheath. In some embodiments, the air volume is an enclosed volume adapted to retain heated air. In different embodiments, the air volume is a partially enclosed volume adapted to expel heated air.

In various embodiments, the first aperture of the resilient sheath has a circumference of approximately 8″ when the resilient sheath is in the first position, and the second aperture of the resilient sheath has a circumference of approximately 6″ when the resilient sheath is in the first position. In various embodiments, at least one raised rib extends above the inner surface of the resilient sheath by between approximately 1/128″ to ½″, and wherein the at least one raised rib has a width of between approximately 1/64″ to 3″.

The dimensions and pressures described herein are representative and may be adapted to engage various extremities and physical tolerances of the human body. For example, shirts and hats may also utilize embodiments of the present invention. Further still, embodiments of the present invention may be used with any animal that has a nervous system. Horse racing is a competitive athletic endeavor, and embodiments of the present invention may be applied to various extremities of a horse to suppress nerves, treat cramps, or even improve the overall performance and/or recovery of the animal. Accordingly, it will be appreciated the dimensions, ranges of pressures, and applications of the invention described herein are exemplary in nature.

In some embodiments, an applicator of the inner surface of the resilient sheath is impregnated with a proprietary compound, wherein the applicator is configured to provide the proprietary compound to the appendage when the resilient sheath is in the second position, wherein the proprietary compound comprises at least one of magnesium, potassium, calcium, and other topically-active ingredients.

Another particular embodiment of the present invention is a nerve suppression device that comprises a sheath having a first end and a second end where a first aperture is positioned at the first end. An inner surface of the sheath defines a partially enclosed volume adapted to receive an appendage, and the sheath is expandable between a first position where the partially enclosed volume is a first volume and a second position where the partially enclosed volume is a second volume. The second volume is larger than the first volume, and the sheath is configured to exert a graded pressure on the appendage where the graded pressure is greater at the second end of the sheath than the graded pressure at the first end of the sheath. At least one raised rib positioned on the inner surface of the sheath, and the at least one raised rib configured to exert a rib pressure on the appendage when the sheath is in the second position. The rib pressure being greater than the graded pressure at the second end of the sheath.

In some embodiments, a second partially enclosed volume is defined by the inner surface of the sheath, the second partially enclosed volume adapted to receive a second appendage. In various embodiments, the at least one raised rib is configured to be positioned over at least one of a superficial peroneal nerve, a deep peroneal nerve, a tibial nerve, a sural nerve, and a saphenous nerve of the appendage. In different embodiments, a raised rib is configured to be positioned over the superficial peroneal nerve, the deep peroneal nerve, and the saphenous nerve of the appendage, and other raised ribs are configured to be positioned over the tibial nerve and the sural nerve of the appendage.

In various embodiments, an interconnection means is disposed along a longitudinal length of the sheath, the interconnection means configured to join two longitudinal sides of the sheath to form the partially enclosed volume. In some embodiments, an air volume is positioned adjacent to the at least one raised rib, wherein the at least one raised rib is configured to deflect an outer surface of the appendage such that the air volume is at least partially defined by the at least one raised rib and the inner surface of the sheath, wherein the air volume is one of an enclosed volume adapted to retain heated air; and a partially enclosed volume adapted to expel heated air.

In different embodiments, the graded pressure changes linearly along a longitudinal length of the sheath between the first end and the second end of the sheath. In some embodiments, the graded pressure is greater than atmospheric pressure, for example, between approximately 5 and 50 mmHg.

Yet another particular embodiment of the present invention is a nerve suppression device, comprising a sheath having a first end and a second end, a first aperture positioned at the first end and a second aperture positioned at the second end, an inner surface of the sheath defining a partially enclosed volume adapted to receive an appendage, the sheath is expandable between a first position where the partially enclosed volume is a first volume; a second position where the partially enclosed volume is a second volume, the second volume is larger than the first volume, and the sheath is configured to exert a sheath pressure on the appendage, wherein the sheath pressure is greater than atmospheric, for example, between approximately 5 and 50 mmHg; at least one raised rib positioned on the inner surface of the sheath and oriented substantially along a longitudinal axis of the sheath between the first end and the second end of the sheath, at least one raised rib configured to exert a rib pressure on the appendage when the sheath is in the second position, the rib pressure being greater than the sheath pressure; wherein at least one raised rib can be configured to be positioned over at least one of a superficial peroneal, deep peroneal, saphenous, posterior tibial, sural nerve of the appendage; and an air volume positioned adjacent to the at least one raised rib, wherein at least one raised rib is configured to deflect an outer surface of the appendage such that the air volume is at least partially defined by the at least one raised rib and the inner surface of the sheath, wherein the air volume is one of an enclosed volume adapted to retain heated air; and a partially enclosed volume adapted to expel heated air. In some embodiments, at least one raised rib extends above the inner surface of the resilient sheath by between approximately 1/128″ to ½″, and at least one raised rib has a width of between approximately 1/64″ to 3″.

These and other advantages will be apparent from the disclosure of the present invention(s) contained herein. The above-described embodiments, objectives, and configurations are neither complete nor exhaustive. The Summary of the Invention is neither intended nor should it be construed as being representative of the full extent and scope of the present invention. Moreover, references made herein to “the present invention” or aspects thereof should be understood to mean certain embodiments of the invention and should not necessarily be construed as limiting all embodiments to a particular description. The present invention is set forth in various levels of detail in the Summary of the Invention as well as in the attached drawings and Detailed Description and no limitation as to the scope of the present invention is intended by either the inclusion or non-inclusion of elements, components, etc. in this Summary of the Invention. Additional aspects of the present invention will become more readily apparent from the Detailed Description particularly when taken together with the drawings.

### BRIEF DESCRIPTION OF THE DRAWINGS

The accompanying drawings, which are incorporated in and constitute a part of the specification, illustrate embodiments of the disclosure and together with the general description of the disclosure given above and the detailed description of the drawings given below, serve to explain the principles of the disclosures.

FIG. 1 is a front elevation view of a right leg with various nerve regions identified in accordance with various embodiments of the invention;

FIG. 2 is a front elevation view of a right leg with various nerves identified in accordance with various embodiments of the invention;

FIG. 3 is a front elevation view of a left leg and a right leg with a common peroneal nerve, a superficial peroneal nerve, and a deep peroneal rib identified in accordance with various embodiments of the invention;

FIG. 4 is a rear elevation view of a left leg and a right leg with a tibial nerve identified in accordance with various embodiments of the invention;

FIG. 5 is a rear elevation view of a left leg and a right leg with a sural nerve identified in accordance with various embodiments of the invention;

FIG. 6 is a front elevation view of a left leg and a right leg with a saphenous nerve identified in accordance with various embodiments of the invention;

FIG. 7 is a side view of a nerve suppression device for a left leg having a rib that corresponds to peroneal nerves in accordance with various embodiments of the invention;

FIG. 8 is a side view of a nerve suppression device for a left leg having a rib that corresponds to a tibial nerve in accordance with various embodiments of the invention;

FIG. 9 is a side view of a nerve suppression device for a left leg having a rib that corresponds to a sural nerve in accordance with various embodiments of the invention;

FIG. 10 is a side view of a nerve suppression device for a left leg having a rib that corresponds to a saphenous nerve in accordance with various embodiments of the invention;

FIG. 11 is a side view of a nerve suppression device for a left leg having ribs that correspond to a superficial peroneal nerve, a deep peroneal nerve, a tibial nerve, a sural nerve, and a saphenous nerve in accordance with various embodiments of the invention;

FIG. 12 is a side view of a nerve suppression device for a left leg having a rib that corresponds to peroneal nerves and a pad for dosing a compound in accordance with various embodiments of the invention; and

FIG. 13 is a side view of a nerve suppression device for a left leg having various exemplary dimensions identified in accordance with various embodiments of the invention.

To assist in the understanding of the embodiments of the present invention the following list of components and associated numbering found in the drawings is provided herein:

| Component No. | Component |
|---|---|
| 2 | Lower Leg |
| 4 | Common Peroneal Nerve |
| 6 | Saphenous Nerve |
| 8 | Deep Peroneal Nerve |
| 10 | Superficial Peroneal Nerve |
| 12 | Tibial Nerve |
| 14 | Sural Nerve |
| 16 | Device |
| 18 | Peroneal Rib |
| 20 | Fastening Mechanism |
| 22 | Tibial Rib |
| 24 | Sural Rib |
| 26 | Saphenous Rib |
| 28 | Portion Pad Applicator |
| 30 | Overall Length |
| 32 | Top Width |
| 34 | Midpoint Width |
| 36 | Bottom Width |

It should be understood that the drawings are not necessarily to scale, and various dimensions may be altered. In certain instances, details that are not necessary for an understanding of the present invention or that render other details difficult to perceive may have been omitted. It should be understood, of course, that the present invention is not necessarily limited to the particular embodiments illustrated herein.

### DETAILED DESCRIPTION

The present invention has significant benefits across a broad spectrum of endeavors. It is the Applicant's intent that this specification and the claims appended hereto be accorded a breadth in keeping with the scope and spirit of the present invention being disclosed despite what might appear to be limiting language imposed by the requirements of referring to the specific examples disclosed. To acquaint persons skilled in the pertinent arts most closely related to the present invention, a preferred embodiment that illustrates the best mode now contemplated for putting the present invention into practice is described herein by, and with reference to, the annexed drawings that form a part of the specification. The exemplary embodiment is described in detail without attempting to describe all of the various forms and modifications in which the present invention might be embodied. As such, the embodiments described herein are illustrative, and as will become apparent to those skilled in the arts, and may be modified in numerous ways within the scope and spirit of the present invention.

Although the following text sets forth a detailed description of numerous different embodiments, it should be understood that the detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims. To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. For example, “device” and “body” may be used interchangeably in some instances.

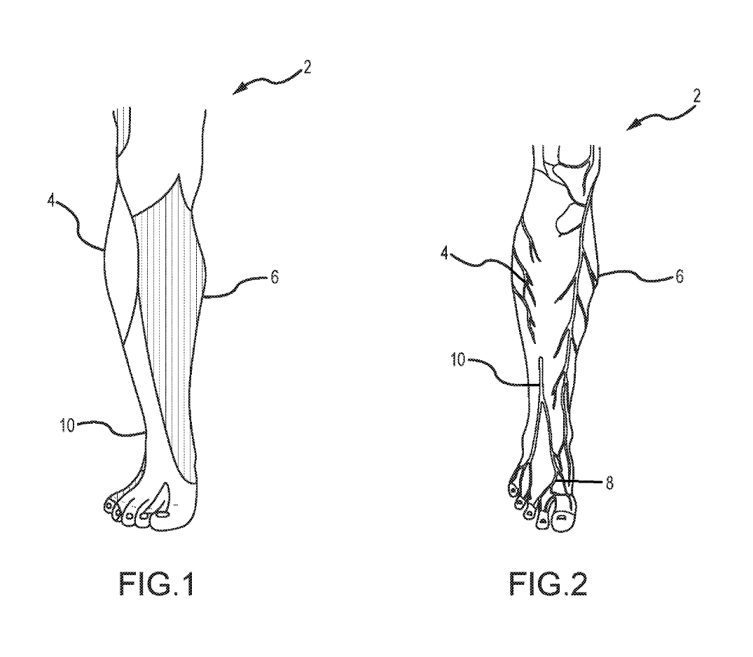

Now referring to FIGS. 1 and 2, front elevation views of a lower right leg 2 are provided that show general regions of nerves in the lower leg 2 that may contribute to cramps or other ailments in the lower leg 2. A common peroneal nerve 4 is positioned on an outer surface of the leg 2, below the knee joint. A saphenous nerve 6 is positioned on the opposite side of the leg 2, below the knee joint down to the ankle joint. A superficial peroneal nerve 10 is positioned on an outer surface of the leg 2, below the common peroneal nerve 4, and the deep peroneal nerve 8 extends down into the foot. While FIG. 1 provides general regions of these nerves 4, 6, 8, 10, FIG. 2 provides a more explicit front perspective view of the various pathways and endings of the common peroneal nerve 4, the saphenous nerve 6, the deep peroneal nerve 8, and the superficial peroneal nerve 10.

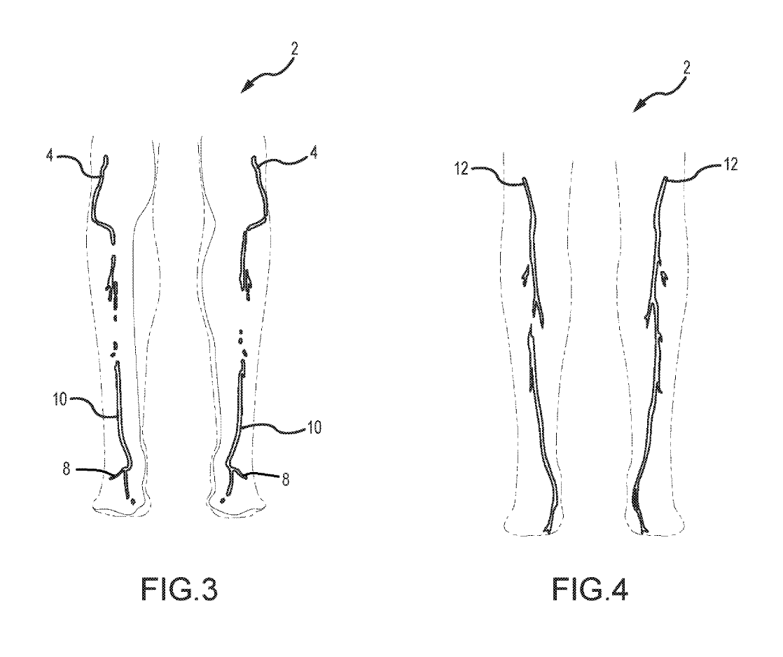

Now referring to FIGS. 3-6, various rear and front elevation views of lower legs are provided to present an alternative view of the various nerve systems of the lower legs. A front elevation view of the common peroneal nerve 4, the superficial peroneal nerve 10, and the deep peroneal nerve 8 are provided in FIG. 3. As in FIG. 1, the common peroneal nerve 4 in FIG. 3 is positioned on an outer surface of the leg 2, below the knee joint, and the superficial peroneal nerve 10 and the deep peroneal nerve 8 are positioned below the common peroneal nerve 4.

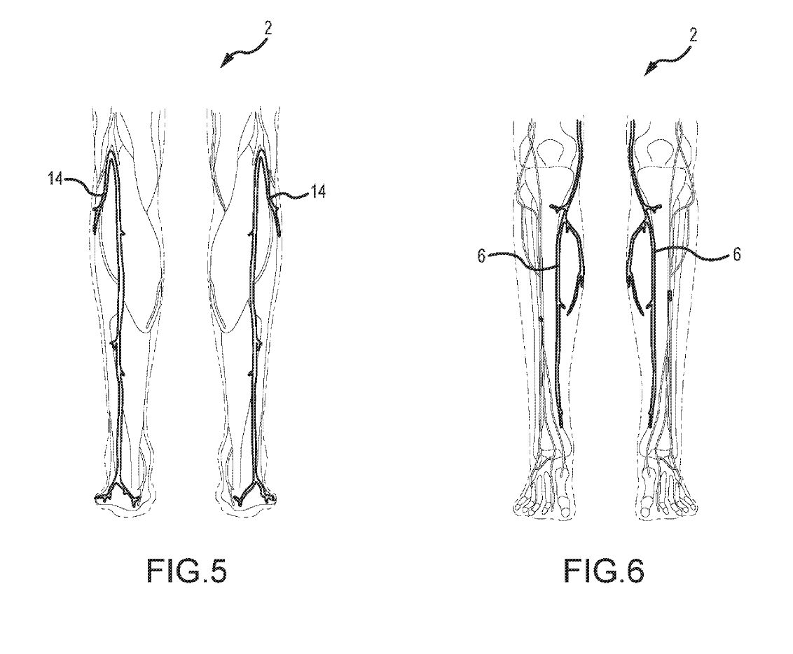

Now referring to FIG. 4, a rear elevation view of a tibial nerve 12 is provided. The tibial nerve 12 extends along the tibia bone in the lower leg 2 and into the foot. FIG. 5 is a rear perspective view of a sural nerve 14, which is positioned on the back side of the lower leg 2 and extends behind the tibia bone and down into the foot. FIG. 6 is a front perspective view of the saphenous nerve 6, which generally extends down the lower leg 2 on an inner surface of the leg 2.

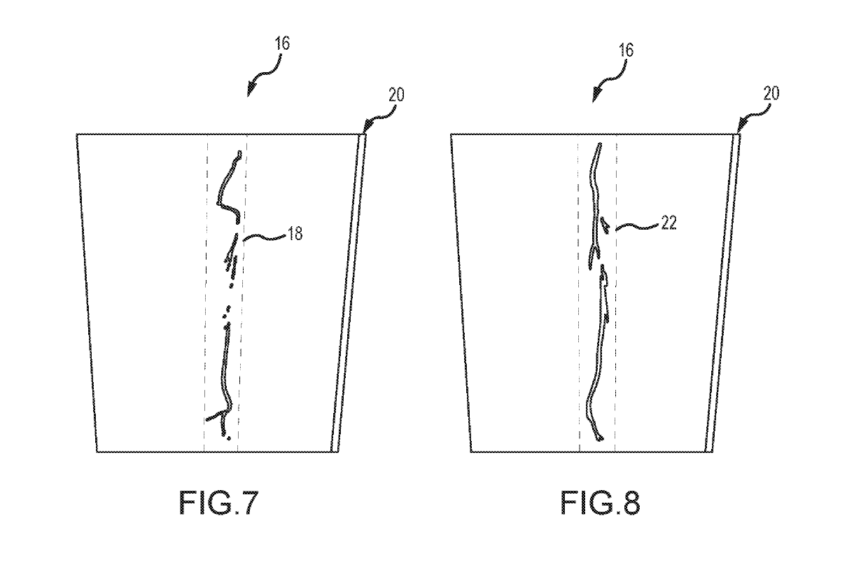

Now referring to FIGS. 7-10, various embodiments of a nerve suppression device 16 are provided that focus pressure on one or more nerves to reduce cramping and other ailments. In FIG. 7, the nerve suppression device 16, which may be a sheath in some embodiments, is laid open and an inner surface of the device 16 is shown. In this view, the nerve suppression device 16 generally has a trapezoidal shape due to the size of the leg tapering to a narrow ankle. Thus, when the nerve suppression device 16 is assembled and placed over an appendage such as a leg, the device 16 generally exerts an even pressure on the leg as a whole and focuses pressure on the representative nerve. It will be appreciated that the device 16 may exert uneven pressure, for example, a graded pressure along a length of the device 16. Further, the shape of the device 16 can be non-trapezoidal in various embodiments.

A fastening mechanism 20, or interconnection means, is shown in FIG. 7, and in some embodiments, the fastening mechanism 20 may include, but is not limited to, zippers, buttons, hook and loop fasteners, magnetic couplings, or any other means that selectively interconnect two sides of the device 16. Once assembled, the device 16 defines a partially enclosed volume having a first aperture and a second aperture for an appendage to pass through. It will be appreciated that alternative embodiments may not include a fastening mechanism 20, and instead the device 16 is a continuous article without a cut made along a longitudinal length of the device 16.

In a relaxed or static state, the nerve suppression device 16 defines a partially enclosed volume having a first volume. Then when the nerve suppression device 16 is positioned over an appendage, the device 16 stretches and the partially enclosed volume has a second volume that is larger than the first volume. The pressure that the device 16 exerts on the appendage may be between approximately 5 and 50 mmHg, and in various embodiments the pressure may vary from top to bottom and/or from side to side. In some embodiments the pressure can be between approximately 0 and 60 mmHg. It will be appreciated that the material of the device 16 and related sheath can be expandable between the first volume and the second volume. For example, elastomerics such as Spandex and Lycra and neoprene are examples of materials that can be used for the device 16, sheath or ribs. In some embodiments, multiple type of materials may be combined. In one instance, the sheath is a resilient material and the rib is made from a rigid material, or alternatively, a rigid material forms the core of a rib, which is then surrounded by a resilient material.

A peroneal rib 18 is provided in FIG. 7 that corresponds to the common peroneal nerve, the deep peroneal nerve, and the superficial peroneal nerve of the lower leg. The peroneal rib 18 is positioned on the inner surface of the device 16 and extends above the inner surface. Therefore, when the device 16 is stretched over the lower leg, the peroneal rib 18 concentrates pressure over the peroneal nerves such that the pressure on the peroneal nerves is greater than the pressure exerted at other locations on the device 16. Stated another way, the rib pressure is greater than the general pressure of the device 16.

The peroneal rib 18 may have various dimensions. For example, in one embodiment, the peroneal rib 18 is raised approximately 1/32″ above the inner surface of the device 16, and the rib 18 is approximately ½″ wide. When viewed from a cross-sectional profile, the shape of the peroneal rib 18 may have a variety of shapes. It will be appreciated that in some embodiments the cross-sectional shape 18 may have a squared profile, a triangular profile, a polygonal profile, a curved profile, etc. The different profiles can elicit different responses in a nerve or nerves. A profile that comes to a point and essentially forms a ridge along a longitudinal length of the rib will concentrate pressure in a small area, and thus, will generate a large effect on the nerve, which may be necessary in instances where the nerve is set deeper from the skin surface.

It will be appreciated that while the peroneal rib 18 is depicted as a continuous area that covers most of the peroneal nerve, the peroneal rib 18, or any other rib described herein, may also be disjointed or discontinuous to exert pressure explicitly on the nerve or nerves. Further, the ribs described herein may extend from a top edge to the bottom edge, and in alternative embodiments, the ribs described herein may not completely extend to the top and bottom edges of the device. Further, yet, the ribs described herein may have variable dimensions along a longitudinal length of the rib. For example, a rib may have a varying height along its length, a varying width along its length, and/or a varying cross sectional profile along its length. Further still, in some embodiments, the rib may refer to an area of studs or discrete features that provide a zone of concentrated pressure among a plurality of features.

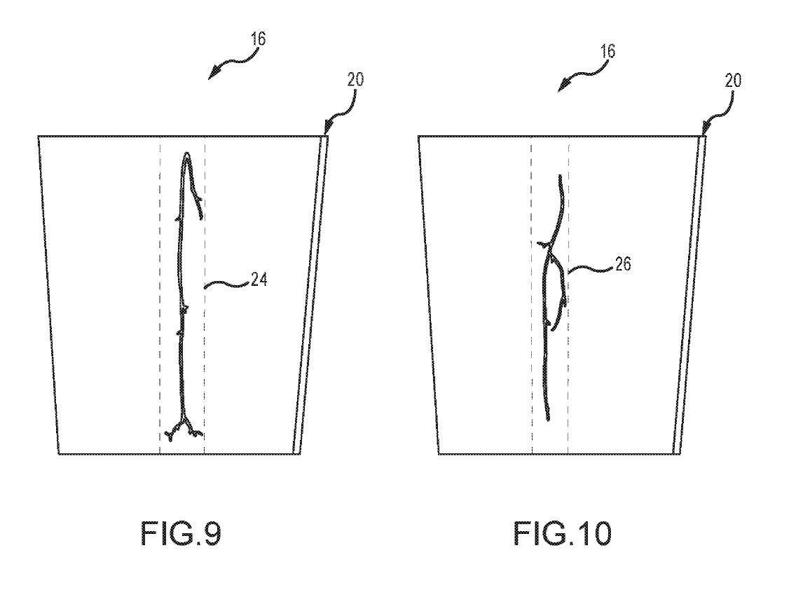

FIGS. 8, 9, and 10 show similar nerve suppression devices 16 having a tibial rib 22, a sural rib 24, and a saphenous rib 26, respectively. These devices 16 also correspond to particular nerves and concentrate the pressure exerted by the device 16. In addition, these devices 16 may have rib dimensions and cross-sectional shapes as disclosed above with respect to FIG. 7.

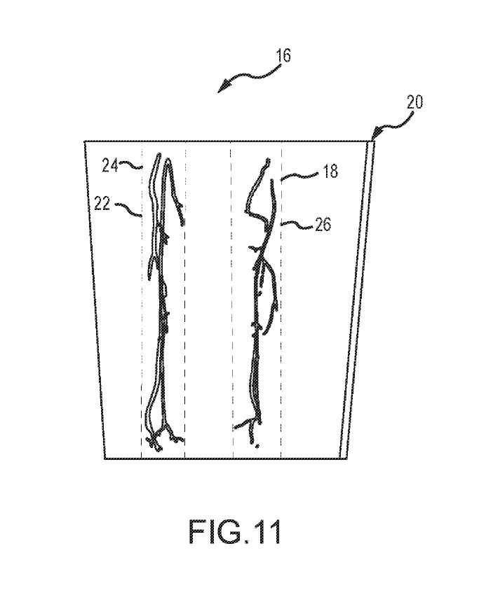

Now referring to FIG. 11, a nerve suppression device 16 with a plurality of ribs 18, 22, 24, 26 is provided. In other embodiments, only one nerve group is targeted with a rib. However, in the embodiment in FIG. 11, two ribs are provided: first rib that is a combined peroneal rib 18 and saphenous rib 26 and second rib that is a combined tibial rib 22 and sural rib 24. These ribs 18, 22, 24, 26 concentrate pressure on various nerves to reduce or eliminate cramping in the lower leg or any other appendage. Again, the devices 16 in FIG. 11 may have rib dimensions and cross-sectional shapes as disclosed above with respect to FIG. 7. It will be appreciated that while this embodiment has ribs 18, 22, 24, 26 that correspond to nerves in the lower leg, other embodiments may have ribs that correspond to nerves in other portions of the body such as the arm.

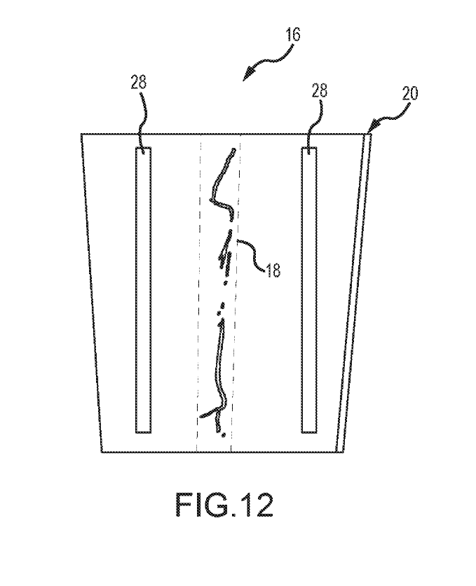

Now referring to FIG. 12, a nerve suppression device 16 is provided that has portion pad applicators 28. These applicators 28 are parts of the nerve suppression device 16 that are impregnated with proprietary compounds, which may inhibit cramps or other ailments. The proprietary compounds may include magnesium, potassium, calcium, and/or any other topically-active ingredient. As shown in FIG. 12, discrete applicators 28 of the device 16 are impregnated with proprietary compounds, and the device 16 can function as a pressure delivery device for the proprietary compound or compounds. However, the rib 18 may also be an applicator 28 and even the entire device 16 may serve as an applicator 28. Further, in some embodiments, the applicators 28 may be selectively removable from the device 16 so that the applicator 28 may be replaced or re-impregnated with new proprietary compounds.

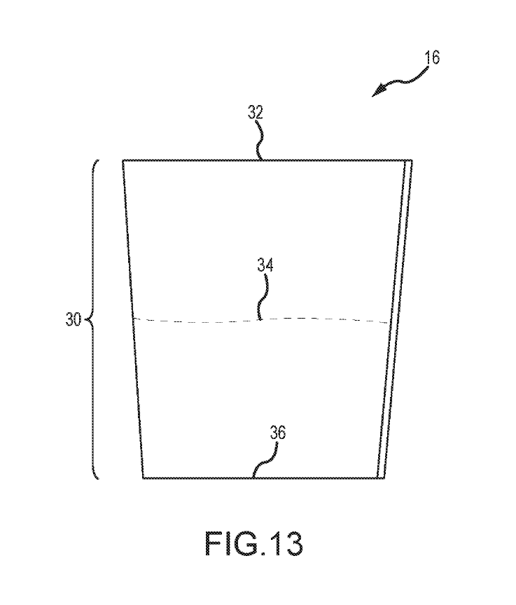

Now referring to FIG. 13, a nerve suppression device is provided with various dimensions identified. The overall length 30 of the device 16 may be between approximately 2″ and 48″. In some embodiments, the overall length 30 may be between approximately 8″ and 14″. In various embodiments, the overall length 30 is approximately 11″.

In various embodiments, a top width 32 of the device 16 is between approximately 2″ and 24″ in a relaxed state. In some embodiments, the top width 32 is between approximately 6″ and 10″ in a relaxed state. In various embodiments, the top width 32 is approximately 8″ in a relaxed state. The top width 32 defines, in part, a first aperture of the device 16 through which the leg passes through.

In various embodiments, a midpoint width 34 is between approximately 3″ and 15″ in a relaxed state. In some embodiments, the midpoint width 34 is between approximately 5″ and 9″ in a relaxed state. In various embodiments, the midpoint width 34 is approximately 7″ in a relaxed state.

In various embodiments, a bottom width 36 of the device 16 is between approximately 3″ and 15″ in a relaxed state. In some embodiments, the bottom width 36 is between 4″ and 8″ in a relaxed state. In various embodiments, the bottom width 36 is approximately 6″ in a relaxed state. The bottom width 36 defines, in part, a second aperture of the device 16 through which the leg passes through.

Embodiments of the present invention may be applied in variety of garments and devices. For example, the nerve suppression device may be pants that stretch around a lower body of a person to exert a pressure on the lower body. Thus, the patents generally have two partially enclosed volumes that extend downward.

The present invention has significant benefits across a broad spectrum of endeavors. It is the Applicant's intent that this specification and the claims appended hereto be accorded a breadth in keeping with the scope and spirit of the present invention being disclosed despite what might appear to be limiting language imposed by the requirements of referring to the specific examples disclosed.

The phrases “at least one”, “one or more”, and “and/or”, as used herein, are open-ended expressions that are both conjunctive and disjunctive in operation. For example, each of the expressions “at least one of A, B, and C”, “at least one of A, B, or C”, “one or more of A, B, and C”, “one or more of A, B, or C,” and “A, B, and/or C” means A alone, B alone, C alone, A and B together, A and C together, B and C together, or A, B, and C together.

Unless otherwise indicated, all numbers expressing quantities, dimensions, conditions, and so forth used in the specification, drawings, and claims are to be understood as being modified in all instances by the term “about.”

The term “a” or “an” entity, as used herein, refers to one or more of that entity. As such, the terms “a” (or “an”), “one or more” and “at least one” can be used interchangeably herein.

The use of “including,” “comprising,” or “having,” and variations thereof, is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C. §112(f). Accordingly, a claim incorporating the term “means” shall cover all structures, materials, or acts set forth herein, and all of the equivalents thereof. Further, the structures, materials, or acts, and the equivalents thereof, shall include all those described in the summary of the present invention, brief description of the drawings, detailed description, abstract, and claims themselves.

The foregoing description of the present invention has been presented for illustration and description purposes. However, the description is not intended to limit the present invention to only the forms disclosed herein. In the foregoing Detailed Description for example, various features of the present invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the present invention.

Consequently, variations and modifications commensurate with the above teachings and skill and knowledge of the relevant art are within the scope of the present invention. The embodiments described herein above are further intended to explain best modes of practicing the present invention and to enable others skilled in the art to utilize the invention in such a manner, or include other embodiments with various modifications as required by the particular application(s) or use(s) of the present invention. Thus, it is intended that the claims be construed to include alternative embodiments to the extent permitted by the prior art.

1. A nerve suppression device, comprising:
a resilient sheath having a first end and a second end, a first aperture positioned at said first end and a second aperture positioned at said second end, an inner surface of said resilient sheath defining a partially enclosed volume adapted to receive an appendage, said resilient sheath is expandable between:
a first position where said partially enclosed volume is a first volume;
a second position where said partially enclosed volume is a second volume, said second volume is larger than said first volume, and said resilient sheath is configured to exert a sheath pressure on said appendage, wherein said sheath pressure is between approximately 5 and 50 mmHg;
at least one raised rib positioned on said inner surface of said resilient sheath, said at least one raised rib configured to exert a rib pressure on said appendage when said resilient sheath is in said second position, said rib pressure being greater than said sheath pressure.

2. The nerve suppression device of claim 1, wherein said at least one raised rib is configured to be positioned over at least one of a superficial peroneal nerve, a deep peroneal nerve, a tibial nerve, a sural nerve, and a saphenous nerve of said appendage.

3. The nerve suppression device of claim 2, wherein a first raised rib is configured to be positioned over said superficial peroneal nerve, said deep peroneal nerve, and said saphenous nerve of said appendage, and a second raised rib is configured to be positioned over said tibial nerve and said sural nerve of said appendage.

4. The nerve suppression device of claim 1, further comprising:
an interconnection means disposed along a longitudinal length of said resilient sheath, said interconnection means configured to join two longitudinal sides of said resilient sheath to form said partially enclosed volume.

5. The nerve suppression device of claim 1, further comprising:
an air volume positioned adjacent to said at least one raised rib, wherein said at least one rib is configured to deflect an outer surface of said appendage such that said air volume is at least partially defined by said at least one raised rib and said inner surface of said resilient sheath.

6. The nerve suppression device of claim 5, wherein said air volume is an enclosed volume adapted to retain heated air.

7. The nerve suppression device of claim 5, wherein said air volume is a partially enclosed volume adapted to expel heated air.

8. The nerve suppression device of claim 1, wherein said first aperture of said resilient sheath has a circumference of approximately 8″ when said resilient sheath is in said first position, and said second aperture of said resilient sheath has a circumference of approximately 6″ when said resilient sheath is in said first position.

9. The nerve suppression device of claim 1, wherein said at least one raised rib extends above said inner surface of said resilient sheath by between approximately 1/128″ to ½″, and wherein said at least one raised rib has a width of between approximately 1/64″ to 3″.

10. The nerve suppression device of claim 1, further comprising:
an applicator of said inner surface of said resilient sheath impregnated with a proprietary compound, wherein said applicator is configured to provide said proprietary compound to said appendage when said resilient sheath is in said second position, wherein said proprietary compound comprises at least one of magnesium, potassium, calcium, and other topically-active ingredients.

11. A nerve suppression device, comprising:
a sheath having a first end and a second end, a first aperture positioned at said first end, an inner surface of said sheath defining a partially enclosed volume adapted to receive an appendage, said sheath is expandable between:
a first position where said partially enclosed volume is a first volume;
a second position where said partially enclosed volume is a second volume, said second volume is larger than said first volume, and said sheath is configured to exert a graded pressure on said appendage, wherein said graded pressure is greater at said second end of said sheath than said graded pressure at said first end of said sheath;
at least one raised rib positioned on said inner surface of said sheath, said at least one raised rib configured to exert a rib pressure on said appendage when said sheath is in said second position, said rib pressure being greater than said graded pressure at said second end of said sheath.

12. The nerve suppression device of claim 11, further comprising:
a second partially enclosed volume defined by said inner surface of said sheath, said second partially enclosed volume adapted to receive a second appendage.

13. The nerve suppression device of claim 11, wherein said at least one raised rib is configured to be positioned over at least one of a superficial peroneal nerve, a deep peroneal nerve, a tibial nerve, a sural nerve, and a saphenous nerve of said appendage.

14. The nerve suppression device of claim 13, wherein a first raised rib is configured to be positioned over said superficial peroneal nerve, said deep peroneal nerve, and said saphenous nerve of said appendage, and a second raised rib is configured to be positioned over said tibial nerve and said sural nerve of said appendage.

15. The nerve suppression device of claim 11, further comprising:
an interconnection means disposed along a longitudinal length of said sheath, said interconnection means configured to join two longitudinal sides of said sheath to form said partially enclosed volume.

16. The nerve suppression device of claim 11, further comprising:
an air volume positioned adjacent to said at least one raised rib, wherein said at least one raised rib is configured to deflect an outer surface of said appendage such that said air volume is at least partially defined by said at least one raised rib and said inner surface of said sheath, wherein said air volume is one of:
an enclosed volume adapted to retain heated air; and
a partially enclosed volume adapted to expel heated air.

17. The nerve suppression device of claim 11, wherein said graded pressure changes linearly along a longitudinal length of said sheath between said first end and said second end of said sheath.

18. The nerve suppression device of claim 11, wherein said graded pressure is between approximately 5 and 50 mmHg.

19. A nerve suppression device, comprising:
a sheath having a first end and a second end, a first aperture positioned at said first end and a second aperture positioned at said second end, an inner surface of said sheath defining a partially enclosed volume adapted to receive an appendage, said sheath is expandable between:
a first position where said partially enclosed volume is a first volume;
a second position where said partially enclosed volume is a second volume, said second volume is larger than said first volume, and said sheath is configured to exert a sheath pressure on said appendage, wherein said sheath pressure is between approximately 5 and 50 mmHg;
at least one raised rib positioned on said inner surface of said sheath and oriented substantially along a longitudinal axis of said sheath between said first end and said second end of said sheath, said at least one raised rib configured to exert a rib pressure on said appendage when said sheath is in said second position, said rib pressure being greater than said sheath pressure; wherein said at least one raised rib is configured to be positioned over at least one of a superficial peroneal nerve, a deep peroneal nerve, a tibial nerve, a sural nerve, and a saphenous nerve of said appendage; and
an air volume positioned adjacent to said at least one raised rib, wherein said at least one raised rib is configured to deflect an outer surface of said appendage such that said air volume is at least partially defined by said at least one raised rib and said inner surface of said sheath, wherein said air volume is one of:
an enclosed volume adapted to retain heated air; and
a partially enclosed volume adapted to expel heated air.

20. The nerve suppression device of claim 19, wherein said at least one raised rib extends above said inner surface of said resilient sheath by between approximately 1/128″ to ½″, and wherein said at least one raised rib has a width of between approximately 1/64″ to 3″.
